(19) United States
(12) Patent Application Publication
(10) Pub. No.: US 2011/0320570 A1
(43) Pub. Date: Dec. 29, 2011

(54) SYSTEMS AND METHODS FOR COMMUNICATING AMONG NODES OF A WIRELESS NETWORK

(76) Inventor: David B. Ewing, Madison, AL (US)

(21) Appl. No.: 13/172,107

(22) Filed: Jun. 29, 2011

Related U.S. Application Data
(60) Provisional application No. 61/359,458, filed on Jun. 29, 2010.

(51) Int. Cl. G06F 15/16

(52) U.S. Cl. 709/218; 709/230

(57) ABSTRACT

A wireless network has a plurality of nodes that are configured to communicate with one another in accordance with a communication protocol of the wireless network. At least one of the nodes is out of range of the other nodes. The out-of-range node is configured to communicate with the other nodes through a network routing server (NRS) that is coupled to the out-of-range node and at least one other node via a network, such as the Internet, having a communication protocol different than the communication protocol of the wireless network. In addition, if desired, a user may utilize a web browser to communicate with any of the nodes of the wireless network when the user does not have physical access to any such nodes.

### CROSS REFERENCE TO RELATED APPLICATION

This application claims priority to U.S. Provisional Patent Application No. 61/359,458, entitled “Systems and Methods for Communicating Among Nodes of a Wireless Network” and filed on Jun. 29, 2010, which is incorporated herein by reference.

### RELATED ART

A wireless sensor network typically has a plurality of nodes having sensors that are used to monitor the operation of devices within a system. Sensor data may be exchanged between the nodes to provide operational control of the devices as may be appropriate for the intended application. However, such wireless sensor networks may be implemented in noisy environments, such as manufacturing plants, affecting the reliability of wireless communication between the nodes. In some cases, a particular node may be unable to communicate with any other node of the network making implementation of such network problematic.

In addition, the nodes of a wireless sensor network may reside in locations that are difficult and/or inconvenient to reach. Accordingly, it may be burdensome or problematic to physically access a given node in order to affect the operation of the node or change its configuration.

Moreover, a heretofore unaddressed need exists for communication systems that enable reliable communication among nodes of a wireless sensor network. It would be desirable for such systems to allow users to easily manage such nodes without requiring the user to directly access at least some of the nodes.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an exemplary embodiment of a system for enabling communication among nodes of a wireless network.

FIG. 2 is a block diagram illustrating an exemplary embodiment of a node of a wireless network, such as is depicted by FIG. 1.

FIG. 3 is a block diagram illustrating an exemplary embodiment of a network routing server (NRS), such as is depicted by FIG. 1.

FIG. 4 is a block diagram illustrating en exemplary embodiment of a communication apparatus, such as is depicted by FIG. 1.

FIG. 5 is a block diagram illustrating en exemplary embodiment of a web server, such as is depicted by FIG. 1.

### DETAILED DESCRIPTION

The present disclosure generally pertains to systems for communicating among nodes of a wireless network. In one exemplary embodiment, a wireless network has a plurality of nodes that are configured to communicate with one another in accordance with a communication protocol of the wireless network. At least one of the nodes is out of range of the other nodes. The out-of-range node is configured to communicate with the other nodes through a network routing server (NRS) that is coupled to the out-of-range node and at least one other node via a network, such as the Internet, having a communication protocol different than that of the wireless network. In addition, if desired, a user may utilize a web browser to communicate with any of the nodes of the wireless network when the user does not have physical access to any such nodes.

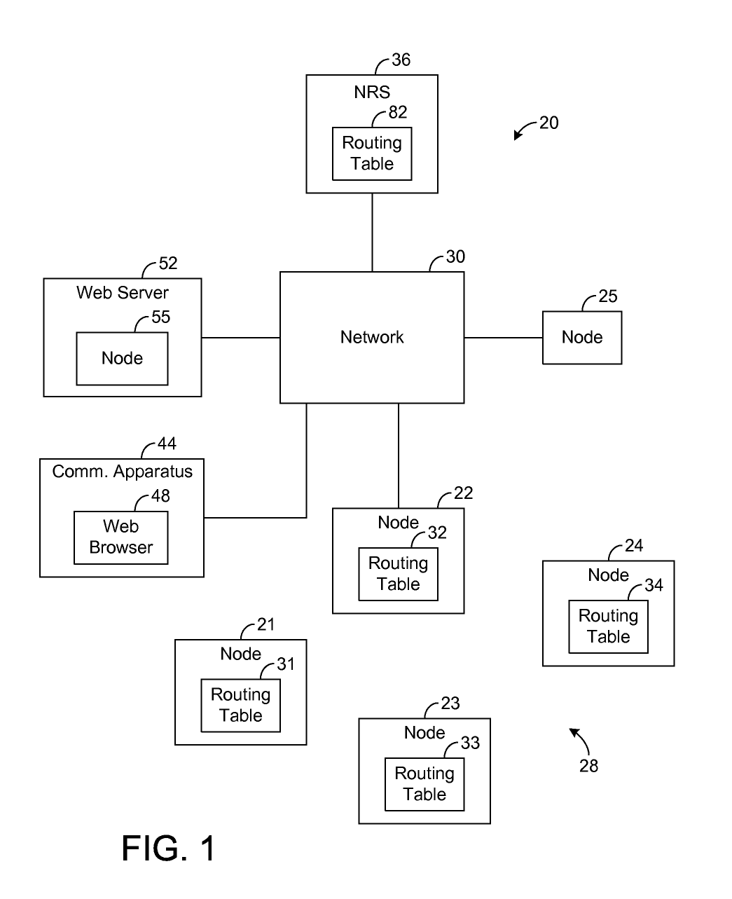

FIG. 1 depicts an exemplary embodiment of a communication system 20. As shown by FIG. 1, the system 20 has a plurality of nodes 21-25 that form a wireless packet network 28. In this regard, each node 21-25 is a member of the network 28 such that messages may be communicated among any of the nodes 21-25 according to a protocol defined for the network 28. The network 28 is identified from other networks, which may employ the same network protocol as the network 28, via an identifier, referred to hereafter as “network identifier.” Each of the nodes 21-25 is aware of the network identifier for the network 28 and includes such network identifier in the overhead of packets that are transmitted over the network 28. Commonly-assigned U.S. patent application Ser. No. 12/463,050, entitled “Systems and Methods for Communicating Messages in Wireless Networks,” and filed on May 8, 2009, which is incorporated herein by reference, describes exemplary nodes that may be used to implement the network 28. Note that the network 28 may have any number of nodes. In one exemplary embodiment, the network 28 is a wireless sensor network (WSN) that is implemented as a mesh network. However, the network 28 may be of another type in other embodiments.

For illustrative purposes assume that the nodes 21-24 are within wireless communication range of each other such that messages may be communicated among the nodes 21-24 wirelessly. Thus, each node 21-24 is able to communicate with any of the other nodes 21-24 without using a network 30, which will be described in more detail below. If desired, any of the nodes 21-24 may communicate with any of the other nodes 21-24 over a physical medium, such as a fiber optic or conductive connection, rather than a wireless connection. Indeed, it is unnecessary for the network 28 to be wireless or completely wireless. For illustrative purposes, assume that the node 25 is remotely located from the nodes 21-24 such that it is out of range of the nodes 21-24 for direct wireless communication.

Messages may hop from node-to-node within the network 28 in order to reach a destination. For example, assume that in the exemplary embodiment shown by FIG. 1 the nodes 21-23 are within wireless communication range of each other such that any of the nodes 21-23 can communicate directly with any of the other nodes 21-23. However, assume that the node 24 is only within wireless communication range of node 23. The other nodes 21 and 22 can use node 23 to route a message to node 24. In this regard, the nodes 21-24 respectively have routing tables 31-34 that indicate routes for messages. As known in the art, routing tables can be created and updated via a variety of techniques. In general, nodes communicate among one another to learn of data paths for various destinations. Once a path to a particular destination is discovered, the routing table or tables of the nodes along the path may be updated and later used to route a message to the destination.

Moreover, to enable the node 21 of network 28 to send a message to node 24, the node 21 may have a routing table 31 indicating that such a message is to hop through the node 23. Thus, the node 21 inserts into the message's header the node identifier, referred to as the message's “hop address,” of the next hop or, in other words, the next node to receive the message (i.e., node 23 in this example), as well as the node identifier, referred to as the “destination address,” of the node (i.e., node 24 in this example) to ultimately receive and process the message. Based on the hop address, the routing node 23 receives the message and consults its routing table 33 to determine where to route the message. In the instant example, the routing table 33 indicates that a message destined for the node 24 can be transmitted directly to the node 24. Thus, the routing node 23 retransmits the message using the node identifier of the node 24 as both the destination address and the hop address for the message. The node 24 receives the message and processes it as appropriate. Thus, even though node 21 cannot communicate directly with the node 24, the node 21 can have the message routed through the network 28 to the node 24. The concept of routing messages through a mesh network using routing tables is generally well-known.

In general, there are at least two types of messages communicated by the network 28, unicast messages and multicast messages. A “unicast” message refers to a message that is destined for a specific node, referred to as the “destination” or “destination node.” Such a message includes a destination address identifying the destination node. In general, a node in the network 28 does not respond to a unicast message unless the node is identified by either the destination address or a hop address in the message. Thus, if a node is not the destination node for a unicast message or within the data path for routing the message to its destination, the node does not respond to the unicast message but rather discards it upon reception. In general, unicast messages also include a source address identifying the node that originated the message and a hop address identifying the next node to receive the message.

In one exemplary embodiment, reliability of data communication is enhanced through the use of acknowledgements. That is, when a node (“receiving node”) receives a unicast message transmitted from another node (“transmitting node”), the receiving node replies with an acknowledgment to the transmitting node. Thus, upon receipt of the acknowledgement, the transmitting node is aware that the unicast message has been received by the receiving node. If the transmitting node does not receive an acknowledgment within a predefined time period after transmission, then the transmitting node assumes that the unicast message failed to reach the receiving node and retransmits the unicast message. Note that each message includes the node identifier of the transmitting node. In addition, an acknowledgement is sent for each respective hop along a data path. Thus, each node along the data path is able to ensure that the next hop has received the unicast message.

A “multicast” message, on the other hand, is a message destined for multiple nodes. In many cases, it is intended for a multicast message to be received and processed by every node in the network 28. Multicast messages are not communicated along predefined data paths indicated by the routing tables of the network nodes, and acknowledgments are not returned for multicast messages. Instead, a multicast message is generally rebroadcast by nodes that receive it regardless of whether such nodes are identified by the message. In general, multicast messages include a source address but no destination or hop address.

In one exemplary embodiment, each multicast message includes a value, referred to as a “time-to-live value,” indicating the number of times that the message is to be retransmitted. Each node that receives a multicast message is configured to retransmit the message as long as the time-to-live value is above a threshold, such as zero. However, before retransmitting the multicast message, the node decrements the time-to-live value. Thus, eventually, a node receives the multicast message after the time-to-live value has been decremented below the threshold and, therefore, does not retransmit the message. Accordingly, depending on the time-to-live value, a multicast message is rebroadcast through the network 28 for a limited time. Note that the same multicast message may be received by multiple nodes and retransmitted by each such node. Thus, after transmission of a multicast message, the message is repeatedly transmitted by other nodes through the network 28 for a finite period of time. In one exemplary embodiment, acknowledgments are not communicated for multicast messages, although the communication of acknowledgments is possible, if desired. Instead, it is assumed that each node of the network 28 has received the multicast message.

To better illustrate aspects of packet routing, exemplary techniques for defining the routing tables 31-34 will be described in more detail below. However, it should be emphasized that various other techniques may be used to define the routing tables 31-34.

Referring to FIG. 1, assume that the node 22 has already discovered a data path to node 24. In this regard, assume that the routing table 32 indicates that a message destined for the node 24 is to hop through the node 23. In this regard, there is an entry for each route defined by the table 32. The entry for the data path to the node 24 includes the node identifier of node 24 as the destination and the node identifier of the node 23 as the next hop in order to reach such destination. Note that there is no need for the table 32 to include the addresses of other hops, if any, along an indicated data path.

If the node 22 is to transmit a message to the node 24, the node 22 transmits a message via at least one data packet. The data packet has a header, which includes a destination address that identifies node 24 and a hop address that identifies node 23. In addition, the routing table 33 of node 23 indicates that a message destined for the node 24 may be communicated directly to the node 24. Thus, when the node 23 receives the foregoing data packet destined for the node 24, the node 23 forwards the packet to the node 24 by changing the hop address to identify node 24 and then retransmitting the packet. In such an example, the node 22 is the source node, the node 24 is the destination node, and the node 23 is a routing node, since a packet from the source to the destination is routed through the node 23. Note that in other examples, there may be more than one routing node.

Now assume that the node 21 has yet to discover a route to the node 24 but desires to communicate with this node 24. Also assume that the node 21 is not within wireless communication range of the node 24. Therefore, direct communication between nodes 21 and 24 is not possible. To discover a route to the node 24, the node 21 broadcasts a message, referred to hereafter as a “route discovery message.” In one exemplary embodiment, the route discovery message is rebroadcast like a multicast message and includes the node identifier of the node 21 that originally broadcast the message. The route discovery message also includes the node identifier of the node 24, referred to as the “destination node,” for which a route is being sought.

When a node, referred to as the “receiving node,” receives a route discovery message, the receiving node determines whether it is the destination node. If it is not the destination node, then the receiving node rebroadcasts the message. However, unlike many other multicast messages, the receiving node includes its own identifier in the rebroadcast message. Thus, the route discovery message, when it is ultimately received at the destination node, will include the node identifier of the node 21 that originally broadcast the message and the node identifiers of all of the hops from such node 21 to the destination node 24. Thus, the message indicates a complete route from the node 21 to the destination node 24. The hop addresses included in the route discovery message are used to enable duplicate filtering of the route discovery message. In this regard, if any of the hop nodes identified in the message receives the message from another node of the network 28, the hop node, in response to its own identifier in the message, refrains from rebroadcasting the message. Thus, the destination node 24 is prevented from receiving multiple “pings” of the same route discovery message from the same hop node.

A node receiving the route discovery message may be configured to update its own routing table based on such message. In this regard, in one exemplary embodiment, if the routing table of a receiving node does not indicate a route for the node 21 that originally transmitted the route discovery message, then the receiving node updates its routing table to include an entry for the original transmitting node 21. The receiving node also updates such entry to include the node identifier of the next hop for the route to the original transmitting node 21 based on the addresses in the route discovery message. In this regard, the node identifier of the next hop included in the routing table entry is the address from which the route discovery message was directly received (i.e., the address of the last hop for the route discovery message). Thereafter, the entry may be later used to transmit a message to the node 21 that originally transmitted the route discovery message.

If the node receiving the route discovery message determines that it is the destination node identified in the message, then the node responds to the route discovery message with a unicast message to the node 21 that originally broadcast the route discovery message. In this regard, the unicast message identifies the original transmitting node 21 (i.e., the source of the route discovery message) and the address of the next hop, which is the same node from which the route discovery message was directly received by the destination node 24. Therefore, the message is routed through the path defined by the addresses in the received route discovery message to the node 21 that originally broadcast the route discovery message. This node 21 then updates its routing table 31 to appropriately indicate the route to the destination node 24. In this regard, the node 21 creates an entry in its routing table 31 and includes the node identifier of the destination node 24. The node 21 also includes the node identifier of the next hop, which is the node from which the unicast message was directly received (i.e., the address of the last hop node for the unicast message prior to being received by the node 21). Note that each unicast message communicated in the network 28 preferably includes the address of the transmitting node (i.e., the node from which the message is being transmitted) and, therefore, the address of message's last hop.

In the instant example, assume that the routing table 31 of the node 21 indicates that messages destined for the node 24 are to be routed through the node 23, which is configured to route such messages directly to the node 24. Thus, if a message is to be transmitted to the node 24, the node 21, based on the routing table 31, transmits at least one packet that identifies the node 24 as the destination and the node 23 as the next hop. Upon receiving the packet, the node 23 forwards the packet to the node 24 based on its routing table 33 by changing the next hop address to that of the node 24.

As shown by FIG. 1, the nodes 22 and 25 are coupled to a network 30, such as a local area network (LAN), a wide area network (WAN), or other type of known or future-developed network. In one exemplary embodiment, the network 30 comprises the Internet, but other types of networks may be used in other embodiments. For illustrative purposes, it will be assumed hereafter that the network 30 is the Internet.

The network 30 is also coupled to a network routing server (NRS) 36. The NRS 36 stores routing information (e.g., a routing table 82) for routing messages for the wireless network 28. In this regard, each node of the network 28 that has access to the network 30 communicates with the NRS 36 to enable the NRS 36 to use such node for routing messages of the network 28, as will be described in more detail hereafter.

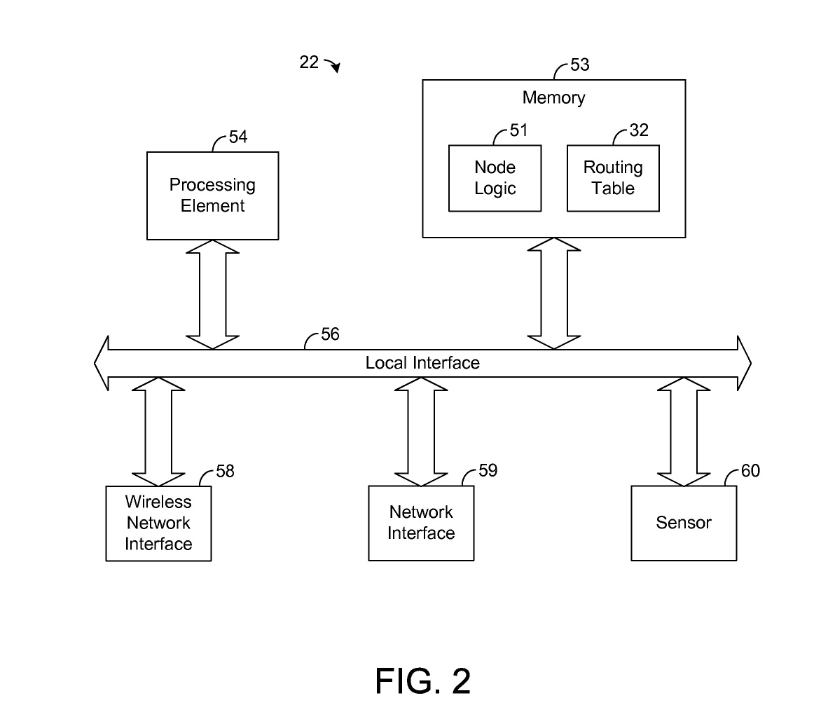

FIG. 2 depicts an exemplary embodiment of the node 22, which is capable of communicating with the NRS 36 through the network 30. As shown by FIG. 2, the node 22 comprises node logic 51 that is configured to control the operation of the node 22. The node logic 51 can be implemented in software, hardware, firmware, or any combination thereof. In the exemplary embodiment illustrated in FIG. 2, the node logic 51 is implemented in software and stored in memory 53, which also stores the node's routing table 32.

Note that the node logic 51, when implemented in software, can be stored and transported on any computer-readable medium for use by or in connection with an instruction execution apparatus that can fetch and execute instructions. In the context of this document, a “computer-readable medium” can be any means that can contain or store a program for use by or in connection with an instruction execution apparatus.

The exemplary embodiment of the node 22 depicted by FIG. 2 comprises at least one conventional processing element 54, such as a digital signal processor (DSP) or a central processing unit (CPU), that communicates to and drives the other elements within the node 22 via a local interface 56, which can include at least one bus. Further, the node 22 comprises a wireless network interface 58 that can be used to communicate wireless signals (e.g., radio frequency signals) with one more nodes 21, 23, or 24 within range of the node 22. In other embodiments, the node 22 can be configured to communicate with one or more other nodes 21, 23, or 23 via physical media, such as fiber optic or conductive connections.

The node 22 also comprises a network interface 59, such as a modem, for enabling the node 22 to communicate with the network 30. Note that the other nodes 21 and 23-25 may be configured similar to the exemplary node 22 shown by FIG. 2. However, for illustrative purposes, it will be assumed that nodes 21, 23, and 24 do not have a network interface 59 for the network 30. In one exemplary embodiment, the network interface 59 of the node 22 is connected to the network 30 via a physical medium, such as a conductive or fiber optic connection. However, the node 22 may be coupled to the network 30 via a wireless connection, if desired.

As indicated above, the network 28 may be a wireless sensor network in which the nodes 21-25 of the network 28 monitor sensors and control devices based on the monitored sensors. Sensor data may be read by one node and passed to another for making a control decision. Also, one node may make a decision based on sensor data and transmit a message to another node instructing the node to control a device coupled thereto in a desired manner based on the sensor data. As shown by FIG. 2, the node 22 may have at least one sensor 60 that provides sensor data on which control decisions can be made.

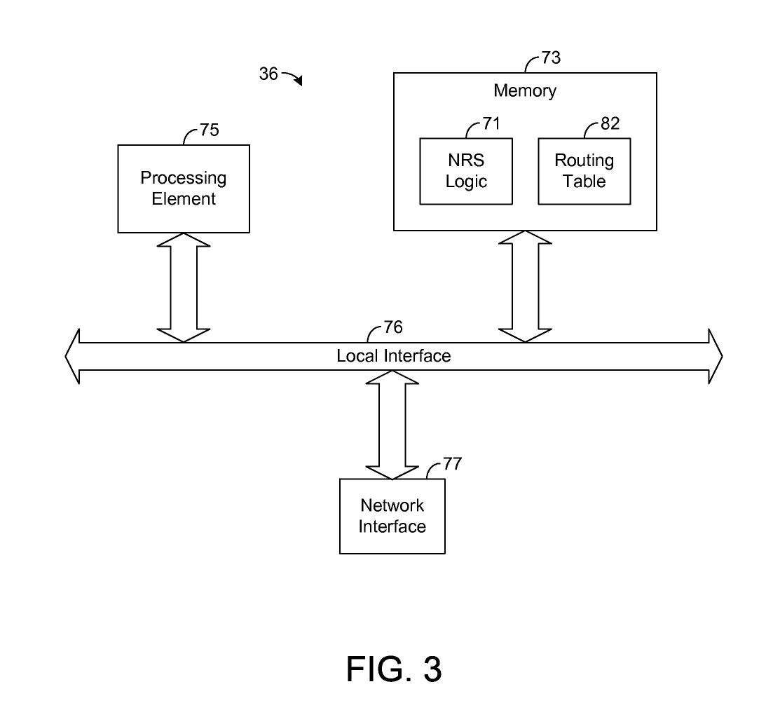

FIG. 3 depicts an exemplary embodiment of the NRS 36. As shown by FIG. 3, the NRS 36 comprises NRS logic 71 that is configured to control the operation of the NRS 36. The NRS logic 71 can be implemented in software, hardware, firmware, or any combination thereof. In the exemplary embodiment illustrated in FIG. 3, the NRS logic 71 is implemented in software and stored in memory 73, which also stores a routing table 82 for the NRS 36. Note that the NRS logic 71, when implemented in software, can be stored and transported on any computer-readable medium for use by or in connection with an instruction execution apparatus that can fetch and execute instructions.

The exemplary embodiment of the NRS 36 depicted by FIG. 3 comprises at least one conventional processing element 75, such as a digital signal processor (DSP) or a central processing unit (CPU), that communicates to and drives the other elements within the NRS 36 via a local interface 76, which can include at least one bus. Further, the NRS 36 comprises a network interface 77, such as a modem, for enabling the NRS 36 to communicate with the network 30. In one exemplary embodiment, the network interface 77 is connected to the network 30 via a physical medium, such as a conductive or fiber optic connection. However, the NRS 36 may be coupled to the network 30 via a wireless connection, if desired.

As described above, one or more nodes 21-24 of the network 28 may use the NRS 36 to route messages for out-of-range nodes of the network 28, such as node 25. Exemplary techniques for using the NRS 36 in such manner will be described below.

In response to connectivity with the network 30, the node 25 is configured to transmit a message, referred to as a “registration message,” to the NRS 36 via the network 30. The registration message includes a node identifier that is used for identifying the node 25 on the network 28, and the registration message includes the network identifier that identifies the network 28 to which the node 25 is a member. The registration message is communicated via transmission control protocol/Internet protocol (TCP/IP) and thus includes the IP address of the node 25. In response to the registration message, the NRS 36 is configured to store in a routing table 82 the node identifier and the IP address of the node 25, as well as the network identifier of the network 28 to which the node 25 is a member.

The node 22 is similarly configured to transmit a registration message to the NRS 36 in response to connectivity with the network 30. Such registration message includes the node identifier of the node 22, the IP address of the node 22, and the network identifier of the network 28 to which the node 22 is a member, and the NRS 36 stores such information. Accordingly, the NRS 36 is aware of the presence of at least the nodes 22 and 25 on the network 28 and has sufficient information (e.g., IP addresses) for communicating with the nodes 22 and 25 via the network 30, which implements a communication protocol different than that of the network 28.

Assume that the node 24 desires to transmit a unicast message to the node 25 via the network 28. Prior to any communication between the nodes 24 and 25, the node 24 may be unaware of a path for communicating a unicast message to the node 25. In such case, the node 24 may initiate a route discovery process for discovering a route to the node 25. In one exemplary embodiment, the node 24 broadcasts a route discovery message that includes the node identifier of the node 25. As indicated above, the route discovery message is preferably a multicast message, but other types of messaging may be used for such message in other embodiments.

Each node that receives the route discovery message checks its routing table to see if it is aware of a route to the node 25 identified by such message. If it is, the node transmits a unicast message back to the node 24 from which the route discovery message originated. If not, then the node rebroadcasts the route discovery message so that other nodes may receive the message and potentially find a route to the desired destination.

In the instant example, assume that the nodes 22 and 23 receive the route discovery message but are unaware of a route to the node 25. In such case both nodes 22 and 23 re-broadcast the route discovery message.

The node 22 considers the connection between the node 22 and the network 30 to be a connection of the network 28. Specifically, such connection connects the node 22 to the NRS 36, which to the node 22 appears to be another node of the network 28. Since the node 22 considers the connection to the network 30 to be another path of the network 28, the node 22 transmits the route discovery message through the network 30 to the NRS 36. In this regard, the node 22 encapsulates such message in one or more TCP/IP packets and transmits the TCP/IP packet or packets to the NRS 36.

Upon receiving the route discovery message, the NRS 36 checks its routing table 82 to determine whether it is aware of a route to the node 25. Since the node 25 previously registered with the NRS 36, as described above, the routing table 82 of the NRS 36 includes the node identifier of the node 25. Accordingly, the NRS 36 transmits a response to the route discovery message back to the node 22. In one exemplary embodiment, the response is a unicast message of the network 28 destined for the node 24 from which the route discovery message originated. The NRS 36 encapsulates such message in one or more TCP/IP packets that are destined for the node 22. Thus, the network 30 transmits the TCP/IP packet or packets to the node 22, which deencapsulates the received packet or packets to recover the unicast response message. The node 22 then forwards the unicast response message to the node 24. According to the techniques described above, the node 22 also updates its routing table 32 to indicate that a message destined for the node 25 is to be transmitted to the NRS 36.

Upon receiving the unicast response message, the node 24 updates its routing table 34 to indicate that the node 22 is the next hop for a message destined for the node 25. Thus, the node 24 is now aware of a path to the node 25 that traverses through the node 22 and the NRS 36. Accordingly, the node 24 transmits a unicast message destined for the node 25, and such message identifies the node 22 as the next hop. The node 22 receives the message and forwards the message to the NRS 36 based on its routing table 32. In this regard, the node 22 encapsulates the message into one or more TCP/IP packets destined for the NRS 36.

Upon receiving the TCP/IP packet or packets, the NRS 36 deencapsulates the packet or packets to recover the message. Using its routing table 82, the NRS 36 determines the IP address of the node 25 and encapsulates the message into one or more TCP/IP packets destined for the node 25. Thus, the node 25 receives the unicast message from the network 30. Accordingly, even though the node 25 is not in direct wireless communication with any of the nodes 21-24, the node 24 is able to find a route to and communicate with the node 22 using the network 30 (e.g., the Internet) and the NRS 36.

Note that a similar process may be used by the node 25 to discover a route for any of the nodes 21-24. For example, assume that the node 25 desires to transmit a message to the node 24 before learning a route to such node 24. In such case, the node 25 may transmit a route discovery message identifying the node 24 to the NRS 36. If the NRS 36 is not storing the node identifier of the node 24, the NRS 36 broadcasts the route discovery message to the nodes of the network 28 identified by the routing table 82 of the NRS 36. Thus, the node 22 receives the route discovery message and replies back to the node 25 through the NRS 36 since it is aware of a route to the identified node 24. In response to such reply, the NRS 36 updates its routing table 82 to include an entry for the node 24, and such entry indicates that the node 22 is the next hop for a message destined for the node 24. Thus, if the NRS 36 later receives a unicast message destined for the node 24, the NRS 36 forwards such message to the node 22 using TCP/IP. Thereafter, the node 25 may transmit to the NRS 36 a unicast message destined for the node 24, and the NRS 36 forwards the message to the node 22, which forwards the message to the node 24.

A user may access the network 28 via any node 21-25 or the NRS 36. However, assume that the user does not have physical access to any node 21-25 or the NRS 36, but the user does have access to a communication apparatus 44 that has a web browser 48. As a mere example, the communication apparatus 44 may be a computer, such as a desk-top, lap-top, or hand-held, e.g., personal data assistance (PDA), computer, or a cellular telephone. Various other types of apparatuses may have a web browser 48 in other embodiments. For illustrative purposes, assume that the apparatus 44 is not configured to support the protocol used by the network 28 for communicating messages.

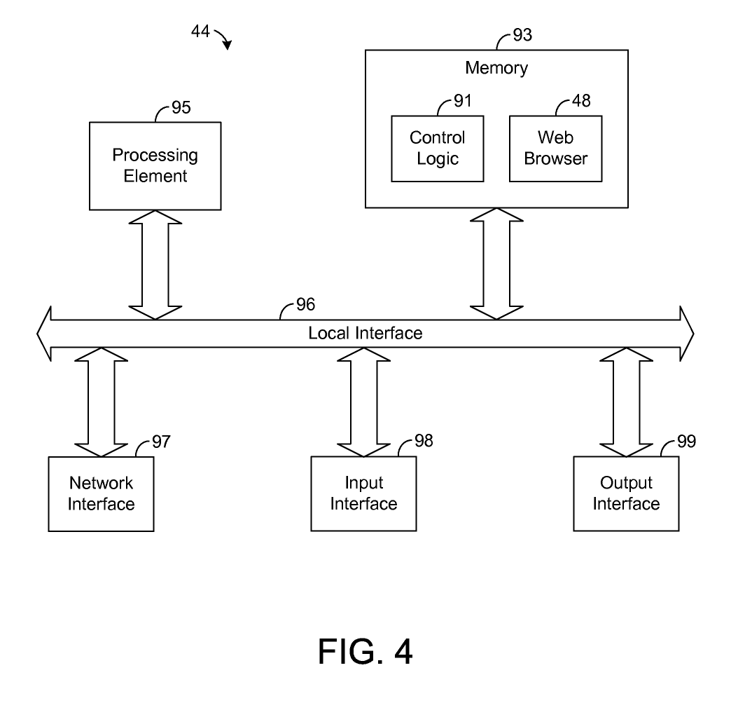

FIG. 4 depicts an exemplary embodiment of the communication apparatus 44. As shown by FIG. 4, the apparatus 44 comprises control logic 91 that is configured to control the operation of the apparatus 44. The control logic 91 can be implemented in software, hardware, firmware, or any combination thereof. In the exemplary embodiment illustrated in FIG. 4, the control logic 91 is implemented in software and stored in memory 93, which also stores the web browser 48. Note that the control logic 91, when implemented in software, can be stored and transported on any computer-readable medium for use by or in connection with an instruction execution apparatus that can fetch and execute instructions.

The exemplary embodiment of the communication apparatus 44 depicted by FIG. 4 comprises at least one conventional processing element 95, such as a digital signal processor (DSP) or a central processing unit (CPU), that communicates to and drives the other elements within the apparatus 44 via a local interface 96, which can include at least one bus. Further, the communication apparatus 44 comprises a network interface 97, such as a modem, for enabling the communication apparatus 44 to communicate with the network 30. In one exemplary embodiment, the network interface 97 is connected to the network 30 via a physical medium, such as a conductive or fiber optic connection. However, the communication apparatus 44 may be coupled to the network 30 via a wireless connection, if desired.

The communication apparatus 44 also comprises an input interface 98, such as a keyboard, keypad, microphone, or a touch screen, that allows a user to provide inputs to the apparatus 44. The communication apparatus 44 further comprises an output interface 99, such as a liquid crystal display (LCD), other type of display screen, or a printer.

Using the input interface 98, the user may access the web browser 48 to establish a connection through the network 30 with a web server 52 via TCP/IP messaging. As shown by FIG. 1, the web server 52 has a node 55 that is compatible with the protocol of the network 28. The node 55 also has a predefined node identifier. In one exemplary embodiment, each node of the network 28 uses a portion (e.g., the last three bytes) of its MAC address as its node identifier in the network 28, but other techniques for determining node identifiers are possible in other embodiments.

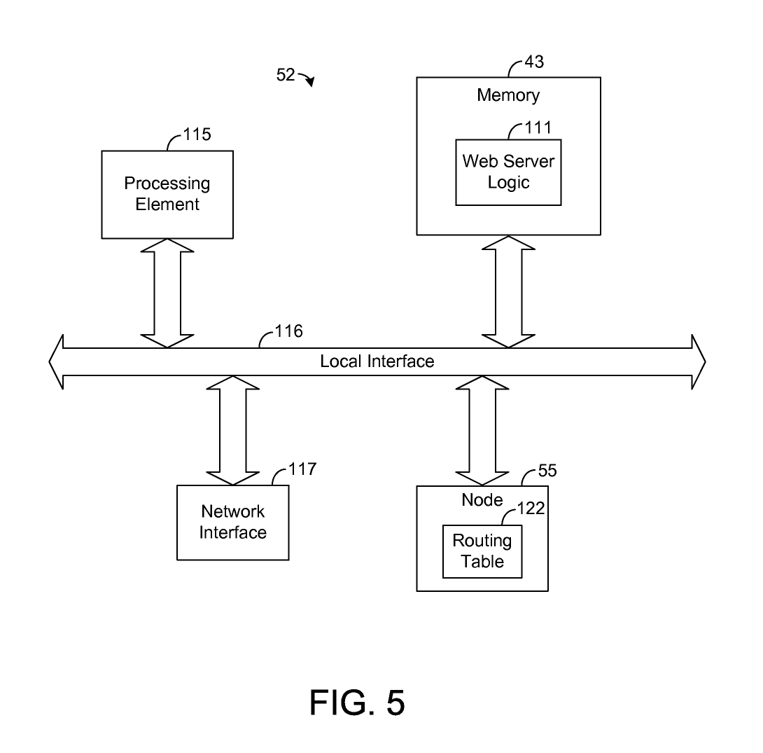

FIG. 5 depicts an exemplary embodiment of the web server 52. As shown by FIG. 5, the web server 52 comprises web server logic 111 that is configured to control the operation of the web server 52. The web server logic 111 can be implemented in software, hardware, firmware, or any combination thereof. In the exemplary embodiment illustrated in FIG. 5, the web server logic 111 is implemented in software and stored in memory 113. Note that the web server logic 111, when implemented in software, can be stored and transported on any computer-readable medium for use by or in connection with an instruction execution apparatus that can fetch and execute instructions.

The exemplary embodiment of the web server 52 depicted by FIG. 5 comprises at least one conventional processing element 115, such as a digital signal processor (DSP) or a central processing unit (CPU), that communicates to and drives the other elements within the web server 52 via a local interface 116, which can include at least one bus. Further, the web server 52 comprises a network interface 117, such as a modem, for enabling the web server 52 to communicate with the network 30. In one exemplary embodiment, the network interface 117 is connected to the network 30 via a physical medium, such as a conductive or fiber optic connection. However, the web server 52 may be coupled to the network 30 via a wireless connection, if desired.

After establishing a connection with the web server 52, the user of the communication apparatus 44 inputs the network identifier for the network 28, and the communication apparatus 44 transmits such network identifier to the web server 52. Upon receiving the network identifier, the web server 52 assigns the network identifier to the node 55 so that the node 55 effectively becomes a member of the network 28.

The node 55 may be configured similar to the other nodes 21-25 of the network 28, and as shown by FIG. 5, the node 55 has a routing table 122. Such routing table 122 has an entry associated with the NRS 36. Such entry includes the IP address of the NRS 36. Such entry may be defined prior to the communication apparatus 44 establishing a connection with the web server 52. However, in one exemplary embodiment, the IP address and node identifier of the NRS 36 is provided by the communication apparatus 44. For example, the IP address of the NRS 36, along with the node identifier of the node 55, may be entered by the user of the apparatus 44 and transmitted to the web server 52, which uses such information to create the routing table entry for the NRS 36 and assign the appropriate node identifier to the node 55. In such an embodiment, the existence of the network 28 may be unknown to the web server 52 prior to communication with the apparatus 44.

Once the web server 52 has assigned a node identifier to the node 55 and created an entry in the routing table 122 for the NRS 36, the node 55 registers with the NRS 36 by transmitting a registration message to the NRS 36, as described above for the nodes 22 and 25. Thus, the NRS 36 adds an entry for the node 55 in its routing table 82. Such entry indicates the node identifier and the IP address of the node 55 and correlates such information with the network identifier of the network 28. The node 55 may now communicate with other nodes 21-25 of the network 28 using the techniques described above for the out-of-range node 25.

For example, a network discovery process may be performed so that the node 55 learns the configuration of the network 28 and the presence of the other nodes 21-25 on the network 28. In this regard, the node 55 may transmit a multicast message, referred to as a “network discovery message.” Such message is transmitted from the node 55 to the NRS 36, which rebroadcasts the message to the nodes 22 and 25. Further, the node 22 rebroadcasts the network discovery message such that it is received by the nodes 21, 23, and 24. Each node 21-25 receiving the network discovery message responds with a unicast reply message destined for the node 55. Upon receiving such replies, the node 55 builds its routing table 122 to include an entry for each node 21-25 of the network 28. Note that any of the other nodes 21-25 may similarly originate a network discovery message to learn the topology of the network 28 and to build its respective routing table.

In addition, the user of the communication apparatus 44 may control any of the nodes 21-25 through the browser 48. In this regard, the web server 52 provides, to the web browser 48, a web page that the user may use to view and provide inputs, such as an input indicating a desire to transmit a command or other message to any node 21-25. Such web page may display the topology of the network 28 based on the information returned to the node 55 via the route discovery process described above. As an example each node 21-25 may be displayed or otherwise indicated via the web page.

For illustrative purposes assume that the user submits through such web page an input for transmitting a command to the node 22. The web server 52 receives the command and causes the node 55 to transmit a message indicative of the command to the NRS 36 using TCP/IP based on the routing table 122. Note that such message includes the node identifier of the node 55 as the message's source address. Thus, to the other nodes 21-25 of the network 28, it appears that the message originated from the node 55 when, in fact, the message is in response to the command from the communication apparatus 44.

The NRS 36 forwards the message indicative of the command, based on the routing table 82, to the node 22 using TCP/IP and the IP address of the node 22. In response, the node 22 performs the action commanded by the original command transmitted from the communication apparatus 44.

Similarly, messages may be communicated in the opposite direction. For example, if the node 22 transmits a reply to the command, such reply is transmitted to the NRS 36 through the network 30 via TCP/IP and the IP address of the NRS 36. The NRS 36 forwards such message, based on the routing table 82, to the node 55 through the network 30 using TCP/IP and the IP address of the node 55. Information from the reply may then be displayed to the user via the web page that is hosted by the web server 52 and accessed via the browser 48. Thus, even if a user does not have physical access to any apparatus that is compatible with the protocol of the network 28, the user can nevertheless access the network 28 through the web server 52 using a device (e.g., apparatus 44) that is compatible with the network 30.

Note that the NRS 36 may provide routing services for many wireless networks, each of which is identified by a unique network identifier. Each routing entry of the NRS 36 may include the network identifier identifying the network to which the entry pertains, and for many messages, the NRS 36 only uses the entries pertaining to the network identified by the respective message. As an example, if the NRS 36 receives a route discovery message from a node 21-25 of the network 28, then the NRS 36 only broadcasts the route discovery message to other nodes of the same network 28, as indicated by the routing table 82.

However, it is possible for a node of one network to communicate with a node of another network through the NRS 36. For example, some message types may allow the transmitting node to specify the node address and the network address for a node on another network. Upon receiving such a message, the NRS 36 may be configured to forward the message to the identified node such that the message traverses over more than one network. Moreover, the NRS 36 may serve as an access point for any network that has at least one node registered with the NRS 36.

Note that it is possible for the network 30 to add delay to the messages communicated through it or to introduce complexities that can disrupt communication. Indeed, many gateways to the Internet employ firewalls that may prevent packets from passing under certain circumstances or add additional delays. In one exemplary embodiment, such delays and disruptions are mitigated by maintaining persistent connections with the NRS 36 and web server 52.

In this regard, as described above, the node 22 is configured to register with the NRS 36. After registration, the node 22 initiates a persistent connection with the NRS 36. In one exemplary embodiment, the foregoing is achieved by transmitting a download request, such as an http “get” request, to the NRS 36. The download request preferably specifies a number of bytes to be downloaded to the node 22 in reply to the request. However, the NRS 36 is configured to send an incomplete reply (i.e., a number of bytes less than the requested amount). Thus, the connection is not closed. In some cases, the NRS 36 may be configured to send a small amount of data periodically to ensure that the connection remains open. In this regard, some firewalls or other software for controlling Internet connectively may close connections based on a time-out. Sending a small amount of data via the connection from the NRS 36 has the effect of restarting such time-out.

If the NRS 36 receives a message that is destined for or is to pass through the node 22, then the NRS 36 may forward the message via the persistent connection. In such case, the message should reach the node 22 with very little delay. In this regard, any firewall between the node 22 and the NRS 36 expects the NRS 36 to provide data over the persistent connection and thus does not interrupt or delay the transmitted message. Accordingly, by maintaining a persistent connection between the NRS 36 and the node 22, the NRS 36 is able to communicate data, such as a message from another node, to the node 22 with very little delay. In other embodiments, other techniques for maintaining persistent connections are possible.

Any of the devices that communicate through the network 30 may similarly maintain persistent connections in an effort to reduce delays. For example, the web browser 48 may maintain a persistent connection to the web server 52, and the web server 52 may maintain a persistent connection to the NRS 36. In addition, each of the nodes 22 and 25 may maintain a respective persistent connection to the NRS 36. Accordingly, messages may be communicated from any node 21-25 and 55 to any other node through the NRS 36 with very little delay.

It should also be noted that the network 30 may be used for communication between any two nodes without the use of the NRS 36 assuming that each node is aware of the IP address of the other node. As an example, the node 25 may be configured to transmit a message to the node 22 through the network 30 without using the NRS 36 if the node 25 is aware of the IP address of the node 22.

In addition, in various embodiments described above, the network 30 is described as comprising the Internet. However, using the Internet is unnecessary, and the network 30 may be implemented via another type or other types of networks, if desired. Such other networks may employ protocols other than TCP/IP. Various other modifications and changes would be apparent to one of ordinary skill in the art upon reading this disclosure.

Now, therefore, the following is claimed:

1. A communication system, comprising:
a first network;
a plurality of nodes of a wireless network including at least a first node, a second node, and a third node, wherein the first network has a communication protocol different than a communication protocol for the wireless network, wherein the first node is configured to communicate wirelessly with the second node, wherein the third node is out of wireless communication range of the first and second nodes, and wherein the first and third nodes are configured to communicate with the first network via the communication protocol of the first network; and
a network routing server (NRS) configured to communicate with the first network via the communication protocol of the first network, the NRS having a routing table for the wireless network, wherein the NRS is configured to receive from the third node a message destined for one of the first and second nodes and to transmit the message across the first network to the first node based on the routing table of the NRS, and wherein the message is compatible with the communication protocol of the wireless network.

2. The system of claim 1, wherein the first node is configured to maintain a persistent connection with the NRS through the first network, and wherein the NRS is configured to transmit the first message to the first node via the persistent connection.

3. The system of claim 1, wherein the first network comprises the Internet, and wherein the NRS is configured to encapsulate the message via transmission control protocol/Internet protocol (TCP/IP).

4. The system of claim 1, further comprising a communication apparatus configured to transmit to the third node via the first network a command for controlling the one node, wherein the third node is configured to transmit the message to the NRS in response to the command, and wherein the message includes a node identifier of the third node as a source address.

5. The system of claim 4, wherein the first network comprises the Internet.

6. The system of claim 5, wherein the communication apparatus comprises a web browser, and wherein the web browser is configured to transmit the command to a web server comprising the third node.

7. A communication method, comprising:
establishing communication between a first network and a network routing server (NRS);
communicating messages via wireless signals between a first node and a second node of a wireless network, the messages in accordance with a first communication protocol of the wireless network;
transmitting a message in accordance with the communication protocol of the wireless network from a third node of the wireless network to the NRS via the first network, wherein the first network has a communication protocol different than the communication protocol of the wireless network, wherein the third node is out of wireless communication range of the first and second nodes, and wherein the message is destined for one of the first and second nodes; and
transmitting, based on a routing table of the NRS for the wireless network, the message from the NRS to the first node via the first network.

8. The method of claim 7, further comprising maintaining a persistent connection through the first network between the first node and the NRS, wherein the message is transmitted via the persistent connection from the NRS to the first node.

9. The method of claim 7, wherein the first network comprises the Internet, and wherein the method further comprises encapsulating the message via transmission control protocol/Internet protocol (TCP/IP).

10. The method of claim 7, further comprising transmitting, from a communication apparatus to the third node via the first network, a command for controlling the one node, wherein the message is transmitted by the third node to the NRS in response to the command, and wherein the message includes a node identifier of the third node as a source address.

11. The method of claim 10, wherein the first network comprises the Internet.

12. The method of claim 11, wherein the communication apparatus comprises a web browser, and wherein the command is transmitted by the web browser.
